(19) United States
(12) Patent Application Publication
(10) Pub. No.: US 2008/0005185 A1
(43) Pub. Date: Jan. 3, 2008

(54) METHOD FOR DECIDING DESIRED IMAGE TO BE RETAINED IN MONITORING APPARATUS

(75) Inventor: Wei Hsu, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 11/470,420

(22) Filed: Sep. 6, 2006

(30) Foreign Application Priority Data
Jun. 30, 2006 (TW) 095123788

(51) Int. Cl. G06F 17/30

(52) U.S. Cl. 707/200

(57) ABSTRACT

A method for deciding the desired image to be retained in a monitoring apparatus is provided. The monitoring apparatus includes a video camera for successively taking images at a focused position to obtain a plurality of image files. In accordance with this method, a file size Fs of each image file is compared with a threshold value TH, thereby deciding which image files should be retained according to the comparing result.

### FIELD OF THE INVENTION

The present invention relates to a monitoring apparatus, and more particularly to a method for deciding the desired image to be retained in the monitoring apparatus.

### BACKGROUND OF THE INVENTION

Conventionally, monitoring apparatuses are widely used in many places in order to monitor some valuable goods, special persons or important things. For example, the monitoring apparatuses are often situated in banks, coffers, post offices, automated teller machines, hospitals or prisons for monitoring cash, patients or prisoners. Nowadays, with increasing demand of the monitoring apparatuses, the monitoring apparatuses are almost omnipresent and situated in more places such as convenience stores, workplaces, community buildings, elevators or parking areas.

Since the monitoring apparatuses have experienced great growth and are now rapidly gaining in popularity, the related technologies for operating the monitoring apparatuses are increasingly developed. Typically, there are two approaches for operating the monitoring apparatuses. According to the first approach, the images are directly recorded into the monitoring apparatuses without implementing compression of image files. The second approach utilizes an image sensor for detecting displacement the images captured by the monitoring apparatuses.

The first approach uses a recording machine to continuously record the images captured by the monitoring apparatus into a hard disk or a videocassette. That is, the captured images are retained and archived. In a case that a controversial issue occurred, certain images associated with the controversial issue should be searched and read to give evidence. Since the archives or the videocassettes for storing the captured images are numerous, it is troublesome and time-consuming to find out these images associated with the controversial issue.

In accordance with the second approach, the image sensor may detect a moving object and discriminate whether the images from the moving object are retained or not. Since only the moving objects in the scene of the camera are retained, this monitoring apparatus is advantageous of saving much memory capacity.

The operation principle of the monitoring apparatus having the image sensor will be illustrated as follows. Firstly, the video camera of the monitoring apparatus is focused on a selected object. The selected object is arranged between the video camera and a monitoring target. For example, in a case that the monitoring target is an automatic teller machine, a coffer or a desk, the selected object is a chair, a box or other object to be focused. At that moment, the position of the selected object is a focal point of the video camera. After the focusing operation is implemented, the object is removed outside the shooting range. Next, the focal point of the video camera is fixed at the focal point where the position of the selected object has previously been, the images of the monitoring target are continuously captured. According to optical principle, there is a depth of field in the vicinity of the focal point, and the images within the depth of field are deemed as sharp images. The sharpness values of the video camera are also called as focus values. Since the video camera is not focused on the monitoring target and no person/object lies within the depth of field, the images captured by the video camera are blurred. If any person or any object enters within the depth of field of the video camera, the image of this person/object becomes sharp. In other words, the focus value is increased when any person or any object enters within the depth of field. As a consequence, the focus value change can be used to discriminate whether the images captured by the monitoring apparatus deserve to be retained. Usually, for discriminating whether the images deserve to be retained, each image file should be decompressed and the focus value thereof is then analyzed. According to the focus value change, the user may decide to retain or discard the image file.

As previously described, the second approach of operating the monitoring apparatus saves more memory capacity when compared with the first approach. However, the second approach still has some drawbacks. For example, since the video camera captures images while the image analysis is done, the systematic resource load of the monitoring apparatus is increased and the processing cost is increased.

In views of the above-described disadvantages of the prior art, the applicant keeps on carving unflaggingly to develop a method for deciding the desired image to be retained in the monitoring apparatus according to the present invention through wholehearted experience and research.

### SUMMARY OF THE INVENTION

It is an object of the present invention to provide a method for deciding the desired image to be retained in the monitoring apparatus according to the image file size, thereby reducing the processing time and saving resource.

In accordance with an aspect of the present invention, there is provided a method for deciding the desired image to be retained in a monitoring apparatus. The monitoring apparatus includes a video camera for successively taking images at a focused position to obtain a plurality of image files. In accordance with this method, a file size Fs of each image file is compared with a threshold value TH, thereby deciding which image files should be retained according to the comparing result.

In an embodiment, if the file size Fs of a current image file is greater than or equal to the threshold value TH, the current image file and the previous N image files are retained. Otherwise, if the file size Fs of a current image file is less than the threshold value TH and the file size Fs of each of the previous N image files is greater than or equal to the threshold value TH, the current image file is retained.

In an embodiment, the image files are compressed by a frequency-domain encoding algorithm.

In an embodiment, the image files comply with the specification of Joint Photographic Experts Group (JPEG).

The above objects and advantages of the present invention will become more readily apparent to those ordinarily skilled in the art after reviewing the following detailed description and accompanying drawings, in which:

### BRIEF DESCRIPTION OF THE DRAWINGS

FIGS. 1.1 to 1.34 schematically illustrate thirty four output images obtained by a monitoring apparatus at a fixed focal point, respectively; and

FIG. 2 is a curve plot illustrating the relation between the captured images versus the image file size.

### DETAILED DESCRIPTION OF THE PREFERRED EMBODIMENT

As previously described, the desired image to be retained in the monitoring apparatus is decided in views of the focus value change according to the prior art. In contrast, the present invention is distinguished by using the image file size as a criterion.

The operation principle of the present invention will be illustrated as follows.

Generally, image files include several specifications such as Bit Map (BMP), Joint Photographic Experts Group (JPEG), Tag Image File Format (TIF), Graphics Interchange Format (GIF), Portable Network Graphics (PNG) and so on. In addition, the multimedia files are compressed by a frequency-domain encoding algorithm. Take a JPEG file for example. First of all, the images taken by an image capture device and having not been processed are referred as raw data. Then, after some processing operations such as image pipeline operations are performed, the images are processed to YCbCr images. The YCbCr images are then processed by a discrete cosine transform (DCT) operation to transform the time-domain images to the frequency-domain images. The frequency-domain images are successively processed by quantization, Huffman coding and Header packaging operations to be converted into JPEG files.

In the above frequency-domain encoding algorithm, the frequency-domain encoding lengths of the images are confirmed after the Huffman coding procedure. In accordance with the specific feature of the present invention, the frequency-domain encoding length correlates to the degree of image complexity. As the encoding length is increased, the degree of image complexity is increased and the sharpness of the image is enhanced. After the Huffman coding procedure, the Header packaging operation is done. Since the file size of the Header is fixed, the extra Header will not influence the relative file size of the JPEG file. Therefore, the image file size is effective as a criterion to discriminate whether the images are sharp or not.

Hereinafter, an embodiment for discriminating whether the image is blurred or shape will be illustrated as follows.

Firstly, a file size threshold value TH is provided according to preliminary experiments. In this embodiment, the file size threshold value TH indicates the file size of the images at the sharpness boundary. If the image file size Fs is greater than or equal to the file size threshold value TH, the captured image is deemed as a sharp image. Otherwise, if the image file size Fs is less than the file size threshold value TH, the captured image is deemed as a blurred image.

In an embodiment of deciding the desired image to be retained, if the current image file size is greater than or equal to the file size threshold value TH, the current image file and the previous three image files are retained. Moreover, if the current image file size Fs is less than the file size threshold value TH but the file sizes of the previous three image files are larger than TH, the current image file is also retained.

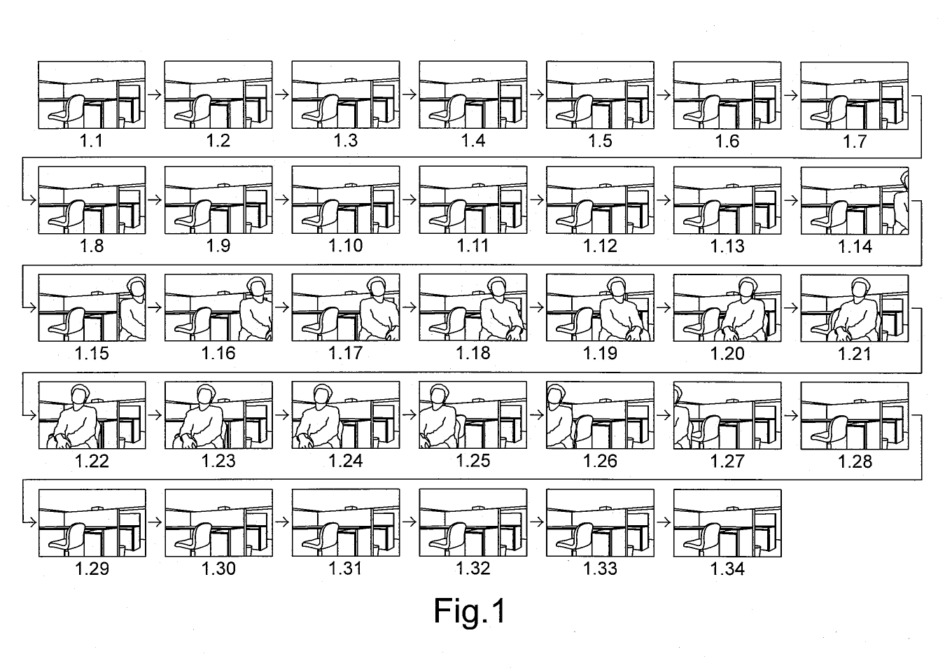

Referring to FIGS. 1.1 to 1.34, thirty four output images obtained by a monitoring apparatus at a fixed focal point are respectively illustrated. The images from FIG. 1.1 to FIG. 1.13 are substantially identical, indicating that no object enters the area to be monitored. The images from FIG. 1.14 to FIG. 1.27 indicate that a moving object/person stays in the monitored area. The images from FIG. 1.28 to FIG. 1.34 indicate that the object/person exits the monitored area.

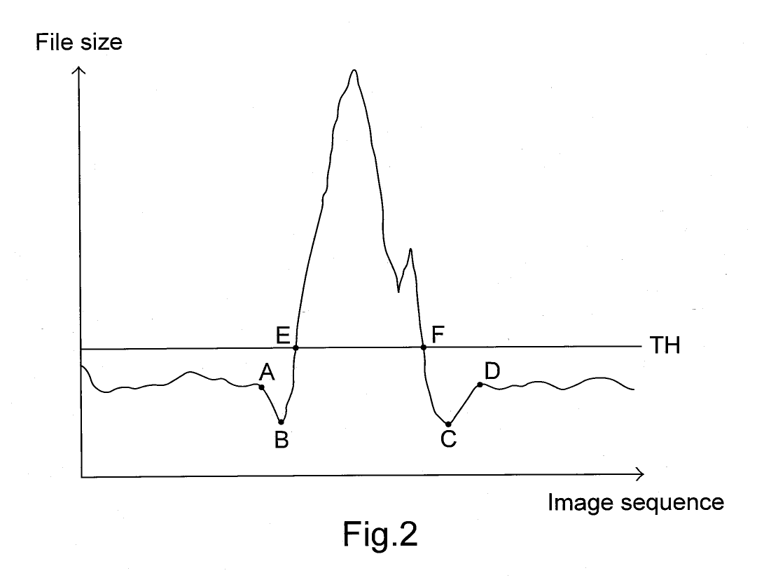

FIG. 2 is a curve plot illustrating the relation between the captured images versus the image file sizes. In FIG. 2, the vertical axle indicates the image file size, and the horizontal axle indicates the image sequence. Please refer to FIG. 1 and FIG. 2. The file size threshold value TH as shown in FIG. 2 is predetermined. The captured images from FIG. 1.1 to FIG. 1.15 are blurred. Correspondingly, as shown in FIG. 2, the image sizes from the start point to the point E (exclusive) are less than the threshold value TH. The point B of FIG. 2 is the first minimum at the early stage and corresponds to the captured image of FIG. 1.14. Meanwhile, an object/person is entering the monitored area. Since the moving object/person is difficult to be focused, the captured image is blurred. At the point E, the current image file size Fs is equal to the threshold value TH and the captured image corresponds to FIG. 1.14. Meanwhile, the object/person stays in the monitored area and the image becomes sharper. The points F, C and D of FIG. 2 correspond to the captured images of FIG. 1.23, 1.25 and 1.27. The image sizes Fs from the point E to the point F are greater than or equal to the file size threshold value TH. Consequently, the image files from the point E to the point F, which correspond to the captured images of FIG. 1.16 to FIG. 1.23, should be retained.

From the above discussion, since the image sizes Fs from the point E to the point F are greater than or equal to the threshold value TH, the captured images of FIG. 1.16 to FIG. 1.23 are sharp images needed to be retained. However, these retained images are insufficient to completely indicate the appearance and the disappearance of the entering object/person. In other words, when the retained images of FIG. 1.16 to FIG. 1.23 are reproduced, it is found that the object/person is abruptly appeared but does not fully leave the monitoring area. For precisely showing the entering direction and the entering time of the object/person, the image of FIG. 1.16 and the previous three images of FIG. 1.13˜1.15 should be also retained. That is, the image files from point A to E are also retained. Likewise, for precisely showing the exiting direction and the exiting time of the object/person, the image of FIG. 1.24 and the following three images of FIG. 1.25˜1.27 should be also retained. That is, the image files from point F to D are also retained. In conclusion, the image files from the point A to the point D should be retained in order to completely indicate the appearance and the disappearance of the entering object/person.

From the above description, the present invention provides a method for deciding the desired image to be retained in the monitoring apparatus according to the image file size. In comparison with prior art, since the procedure of analyzing the focus values of the images is omitted, the present invention is advantageous of saving image processing time associated with decision of the desired image to be retained, thereby saving resource of the monitoring apparatus.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for deciding the desired image to be retained in a monitoring apparatus, said monitoring apparatus including a video camera for successively taking images at a focused position to obtain a plurality of image files, said method comprising steps of:
comparing a file size Fs of each image file with a threshold value TH; and
deciding which image files should be retained according to the comparing result.

2. The method according to claim 1 wherein if the file size Fs of a current image file is greater than or equal to said threshold value TH, said current image file and the previous N image files are retained, or if the file size Fs of a current image file is less than said threshold value TH and the file size Fs of each of the previous N image files is greater than or equal to said threshold value TH, said current image file is retained.

3. The method according to claim 2 wherein said image files are compressed by a frequency-domain encoding algorithm.

4. The method according to claim 3 wherein said image files comply with the specification of Joint Photographic Experts Group (JPEG).
